(19) United States
(12) Patent Application Publication
(10) Pub. No.: US 2013/0093283 A1
(43) Pub. Date: Apr. 18, 2013

(54) SPINDLE MOTOR

(71) Applicant: SAMSUNG ELECTRO-MECHANICS CO., LTD., Gyunggi-do (KR)

(72) Inventors: Ho Jun Yoo, Gyunggi-do (KR); Kyung Su Park, Gyunggi-do (KR)

(73) Assignee: SAMSUNG ELECTRO-MECHANICS CO., LTD., Gyunggi-do (KR)

(21) Appl. No.: 13/650,036

(22) Filed: Oct. 11, 2012

(30) Foreign Application Priority Data
Oct. 12, 2011 (KR) 10-2011-0104128

(51) Int. Cl. H02K 1/16

(52) U.S. Cl. 310/216.069

(57) ABSTRACT

Disclosed herein is a spindle motor. The spindle motor uses a general (non neodymium) permanent magnet rather than a neodymium magnet as a permanent magnet and compensates for a reduced counter electromotive force (B-EMF) value by allowing the center of a connection part formed in a round shape between poles around which coils are wound to be different from that of a core to increase a coil inductance value, thereby making it possible to easily sense and control a rotation state of the spindle motor.

### CROSS REFERENCE TO RELATED APPLICATION

This application claims the benefit of Korean Patent Application No. 10-2011-0104128, filed on Oct. 12, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

In a spindle motor, a shaft rotates while maintaining a predetermined contact section between a bearing and the shaft, such that rotational characteristics may be stably maintained. Therefore, the spindle motor has been widely used as a unit for driving a recording medium requiring high speed rotation, such as a hard disk drive (HDD), an optical disk drive (ODD), or the like.

The spindle motor generally includes an armature, a rotor including a permanent magnet generating electromagnetic force between the permanent magnet and the armature, and a stator rotatably supporting the rotor, and rotates the rotator by electromagnetic force generated between the armature and the permanent magnet to easily drive the recording medium.

Meanwhile, the spindle motor should necessarily include the permanent magnet due to a principle thereof As the permanent magnet, a neodymium (hereinafter, referred to as ND) magnet is generally used The reason why the ND magnet is used is that it has magnetism stronger than that of a ferrite magnet which is a general (that is, a non ND) permanent magnet, such that it is appropriate as a permanent magnet of the spindle motor.

However, a manufacturing cost of the spindle motor using the ND magnet as the permanent magnet has continuously increased, which is caused by a rapid increase in a cost of a rare earth material.

In order to solve this problem, the general (non ND) permanent magnet may be used instead of the ND magnet. However, in this case, a problem may occur in sensing a rotation state of the spindle motor, such that a case in which the spindle motor is not controlled may occur.

That is, the sensing of the rotation state of the spindle motor is controlled through a counter electromotive force (B-EMF) value generated in each phase at the time of rotation of the spindle motor. In the case in which the counter electromotive force (B-EMF) value is small, a case in which the sensing of the rotation state of the spindle motor is not controlled has occurred.

Here, the counter electromotive force (B-EMF) value is a value generated by summing coil inductance and force of the permanent magnet, which is represented by the following Equation.

B-EMF Value=Coil Inductance+Force of Permanent Magnet

Therefore, in order to compensate for the reduced force of the permanent magnet, an inductance value which is an electrical magnitude of a coil should be increased. However, a core according to the prior art has a restrictive factor in increasing the inductance value.

The core according to the prior art has been disclosed in Patent Document 1. As shown in FIG. 1 of Patent Document 1, the center of an inner side round around which coils are wound, more specifically, the center of a connection part formed between poles around which the coils are wound is the same as the center of the core, such that there is a limitation in increasing the inductance value.

Therefore, a technology of solving a problem that may be generated due to the use of the core according to the prior art disclosed in Patent Document 1 in using a general (non ND) permanent magnet instead of an ND permanent magnet has been demanded.

### PRIOR ART DOCUMENT

### Patent Document

(Patent Document 1) KR2011-0037371 A

### SUMMARY OF THE INVENTION

The present invention has been made in an effort to provide a spindle motor of which a rotation state may be easily sensed and controlled at the time of using a general (non ND) permanent magnet.

According to a preferred embodiment of the present invention, there is provided a spindle motor including: an armature including a core; a rotor disposed at an upper portion of the armature and including a permanent magnet facing the core; and a stator having the armature provided at an upper portion thereof and rotatably supporting the rotor, wherein the core has poles radially arranged and formed based on the center and having coils wound therearound and has a connection part formed between the poles and having the center different from the center.

The permanent magnet may include a ferrite magnet.

The connection part may be formed to have a round of R0.1 or more.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view showing a spindle motor according to a preferred embodiment of the present invention;

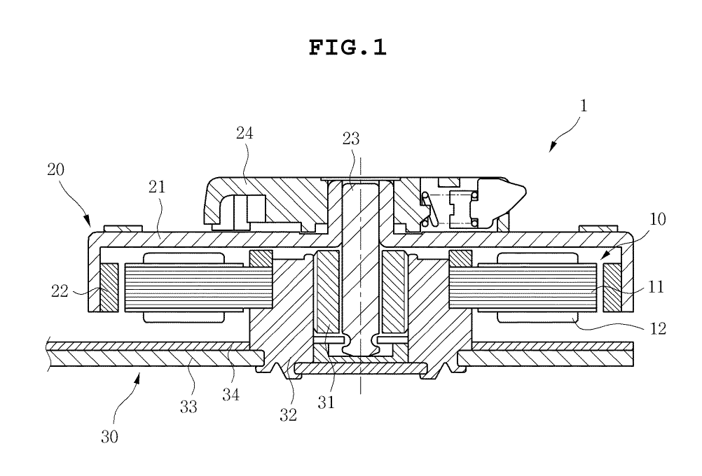

FIG. 2 is a plan view showing a core according to a first preferred embodiment of the present invention; and

FIG. 3 is a plan view showing a core according to a second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

A spindle motor 1 according to a preferred embodiment of the present invention includes an armature 10, a rotor 20, and a stator 30. In addition, the armature 10 includes a core 11 that has poles 11b radially arranged and formed based on the center C and having coils wound therearound and has a connection part 11c formed between the poles 11b and having the center different from the center C.

Here, the rotor 20 and the stator 30 except for the armature 10 are general components and may be easily implemented without a detailed description thereof However, the rotor 20 and the stator 30 will be briefly described below in order to assist in the understanding of the present invention. A description of the well-known technology judged to unnecessarily make the gist of the present invention obscure will be omitted.

The rotor 20 may include a rotor case, a permanent magnet, and a shaft. In addition, the rotor 20 may further include a clamp 24 installed on the rotor case 21 to fix a recording medium, that is, a magnetic disk or an optical disk.

That is, the rotor 20 is rotatably installed at the stator 30 by installing the rotor case 21 at an upper portion of the shaft 23, disposing the permanent magnet 22 in the rotor case 21 so as to face the armature 10, and then inserting the shaft 23 into a bearing 31. Here, as the permanent magnet 22, a ferrite magnet is used

The stator 30 includes the bearing 31 supporting the shaft 23 and a bearing holder 32 having the bearing 31 embedded therein, wherein the bearing holder 32 includes the armature 10 fixed to an outer portion thereof through the core 11.

Here, the stator 30 further includes a base plate 33 at which the bearing holder 32 is installed and a substrate 34 supplying external power to the armature 10.

Therefore, at the time of supplying of the external power through the substrate 34, the shaft 23 supported by the bearing 31 is rotated by electromagnetic force generated by the permanent magnet 22 and the armature 10, such that the rotor 20 including the shaft 23 is rotated. Therefore, the recording medium elastically mounted on the clamp 24 is rotated to record or reproduce data.

Meanwhile, the spindle motor 1 according to the preferred embodiment of the present invention uses the ferrite magnet, which is a general (not ND) permanent magnet, as the permanent magnet 22, as described above. Therefore, an electromotive force (B-EMF) value for sensing a rotation state of the spindle motor 1 is reduced. According to the preferred embodiment of the present invention, the reduced electromotive force (B-EMF) value is compensated for by the core 11.

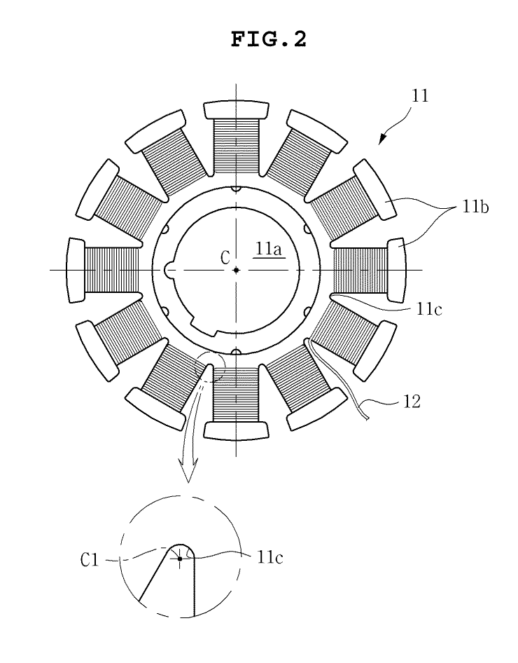

The core 11 has the poles 11b radially arranged and formed based on the center C and having coils wound therearound, as shown in FIG. 2, which is the same configuration as that of the core according to the prior art.

However, the connection part 11c connecting the poles 11b to each other is formed so as to have the center different from the center C of the core 11. Here, the center of the connection part 11c will be called the second center C1 in order to prevent confusion with the center C described above.

Therefore, it is easier to increase a size of the pole 11b in the core 11 according to the preferred embodiment of the present invention than the core according to the prior art under a condition in which a size of an appearance of the core 11 according to the preferred embodiment of the present invention is the same as that of the core according to the prior art. Accordingly, in the core 11 according to the preferred embodiment of the present invention, a coil inductance value which is an electric magnitude of the coil may be increased, thereby compensating for force of the permanent magnet 22 reduced due to the use of the ferrite magnet.

In the core 11 according to a first preferred embodiment of the present invention, an inner diameter portion 11a is formed so that the core 11 is disposed on the stator 30, the poles 11b are radially arranged and formed based on the center C, and the connection part 11c connecting the poles 11b is formed to have a round of R0.5 which is R0.1 or more based on the second center C1 to increase a width of the pole 11b around which the coil 12 is wound, as shown in FIG. 2.

Therefore, according to the first preferred embodiment of the present invention, the coil 12 may be wound around the pole 11b so as to be wider as compared to the core according to the prior art in the condition in which the size of the appearance of the core 11 is the same as that of the core according to the prior art. Therefore, the coil inductance value may be increased to compensate for the force of the permanent magnet 22 reduced due to the use of the ferrite magnet.

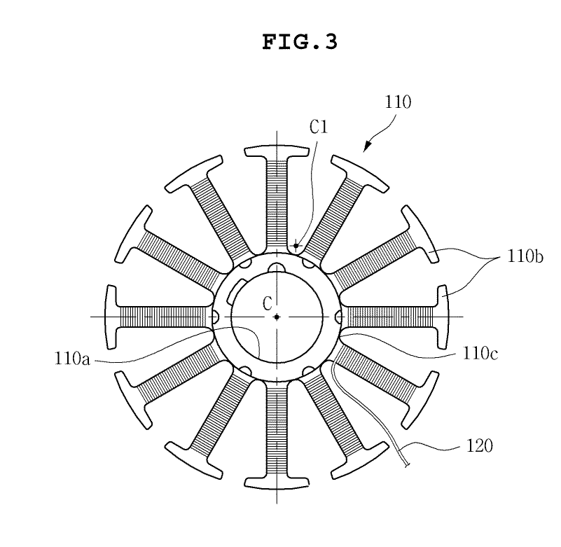

In the core 110 according to a second preferred embodiment of the present invention, an inner diameter portion 110a is formed so that the core 110 is disposed on the stator 30, the poles 110b are radially arranged and formed based on the center C, and the connection part 110c connecting the poles 110b is formed to have a round of R0.5 which is R0.1 or more based on the second center C1 to increase a length of the pole 110b around which the coil 12 is wound, as shown in FIG. 3.

That is, in the core 110 according to the second preferred embodiment of the present invention, the connection part 110c is formed to have a round of R0.5 in a state in which a width of the pole 110b is not increased, such that the length of the pole 110 rather than the width thereof is increased by 5%, thereby increasing the number of coils 120 wound around the pole 110bTherefore, the coil inductance value may be increased to compensate for the force of the permanent magnet 22 reduced due to the use of the ferrite magnet.

The following Table shows results of confirming inductance values of the core according to the prior art and the cores 11 and 110 according to the first and second preferred embodiment of the present invention and comparing counter electromotive force (B-EMF) values and characteristic values at time of spin-up for specifications of using a ferrite magnet which is the general (non ND) permanent magnet with each other.

TABLE 1

| | | | First | | Second | |
|---|---|---|---|---|---|---|
| | Comparative | | Preferred | | Preferred | |
| | Example | | Embodiment | | Embodiment | |
| Inductance Value | 340 | μH | 380 | μH | 400 | μH |
| B-EMF Value | 400 | mV | 428 | mV | 443 | mV |

| | | | |
|---|---|---|---|
| Cogging | No Problem | No Problem | No Problem |
| FG Step Out Phenomenon | No Problem | No Problem | No Problem |
| at the time of Spin-up | | | |
| 4.75 V | | | |
| FG Step Out Phenomenon | FG Step Out | No Problem | No Problem |
| at the time of Spin-up | Phenomenon | | |
| 5.00 V | Occurs | | |
| FG Step Out Phenomenon | FG Step Out | FG Step Out | No Problem |
| at the time of Spin-up | Phenomenon | Phenomenon | |
| 5.25 V | Occurs | Occurs | |

That is, it has been confirmed in Table 1 that in the case of Comparative Example in which the core according to the prior art is used under a condition in which the ferrite magnet rather than the ND magnet is used, an FG step out phenomenon at the time of spin-up does not occur under a condition of 4.75 V; however, a problem at the time of rotation as well as an FG step out phenomenon occurs under a condition of 5.00 V and 5.25 V.

However, it has been confirmed that in the case of using the cores 11 and 110 according to the first and second preferred embodiments of the present invention, a problem does not occur in both of the first and second preferred embodiments under a condition of 5.00 V and does not occur in the second preferred embodiment under a condition of 5.25V, as compared to Comparative Example.

Therefore, in the spindle motor 1 according to the preferred embodiment of the present invention, the coil inductance value is increased to compensate for the force of the permanent magnet reduced due to the use of the ferrite magnet which is the general (non ND) magnet rather than the ND magnet, such that a decrease in the counter electromotive force (B-EMF) value is prevented, thereby making it possible to easily sense and control the rotation state of the spindle motor.

As set forth above, according to the preferred embodiment of the present invention, even though the general (non ND) permanent magnet including a ferrite magnet rather than the ND magnet is used as the permanent magnet, the coil inductance value is increased, thereby making it possible to compensate for the force of the permanent magnet reduced due to the use of the ferrite magnet. Therefore, the rotation state of the spindle motor may be easily sensed and controlled through the counter electromotive force (B-EMF) value.

In addition, the ND magnet is not used, such that a factor of an increased cost is removed, thereby making it possible to secure a competitive cost.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor comprising:
an armature including a core;
a rotor disposed at an upper portion of the armature and including a permanent magnet facing the core; and
a stator having the armature provided at an upper portion thereof and rotatably supporting the rotor,
wherein the core has poles radially arranged and formed based on the center and having coils wound therearound and has a connection part formed between the poles and having the center different from the center.

2. The spindle motor as set forth in claim 1, wherein the permanent magnet includes a ferrite magnet.

3. The spindle motor as set forth in claim 1, wherein the connection part is formed to have a round of R0.1 or more.
